(19) United States
(12) Patent Application Publication
(10) Pub. No.: US 2012/0311986 A1
(43) Pub. Date: Dec. 13, 2012

(54) Leaf-net

(76) Inventors: James Kendall Anderson, Cincinnati, OH (US); Lisa Elaine Anderson, Cincinnati, OH (US)

(21) Appl. No.: 13/134,541

(22) Filed: Jun. 10, 2011

(51) Int. Cl. A01D 51/00

(52) U.S. Cl. 56/1

(57) ABSTRACT

A device to make the chore of raking and disposal of leaves easier. This is a specifically designed net comprised of a strong biodegradable material or a nylon type material with a drawstring embroidering the net. This net is specifically for the gathering and disposing of leaves.

### BACKGROUND OF THE INVENTION

1. Field of the Invention

Raking, gathering and discarding leaves are a major task. Many communities are seeking an environmental friendly method of leaf disposal. It takes considerable effort, rake these leaves into piles and put these leaves into bags or containers. This process can be extremely cumbersome to someone suffering from backaches, arthritis, heart trouble or other ailments. The present invention provides a device that will minimize the use of a rake. The present invention allows the individual to collect the leaves in a form in which they may be directly composted. It is an object of this invention to provide a device which will collect leaves on the ground and allow their transport to the point of composting.

2. Description of the Prior Art

Numerous patents have been granted for the gathering and carrying of items. Examples of such devices are shown in U.S. Pat. Nos. 4,738,545; 4,682,447; 4,366,949; 4,337,812; 2,626,648. A need has arisen for a device to gather leaves, using a drawstring.

### SUMMARY OF THE INVENTION

It is the object of the present invention to provide a less cumbersome way of gathering and disposing leaves. The biodegradable net does the actual gathering of the leaves as they fall from the trees. The drawstring is pulled to ready leaves for disposal or composting.

### BRIEF DESCRIPTION OF THE DRAWINGS

FIG. 1 is an overview of the net as it spread out on the lawn. With reference to FIG. 1, the net is comprised of a strong, biodegradable material and ground stakes.

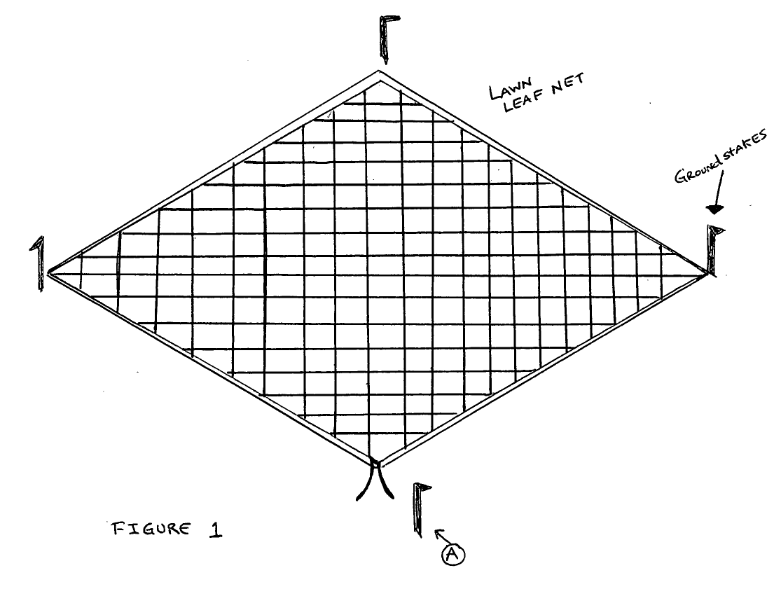

FIG. 2 displays a drawstring bordering the net.

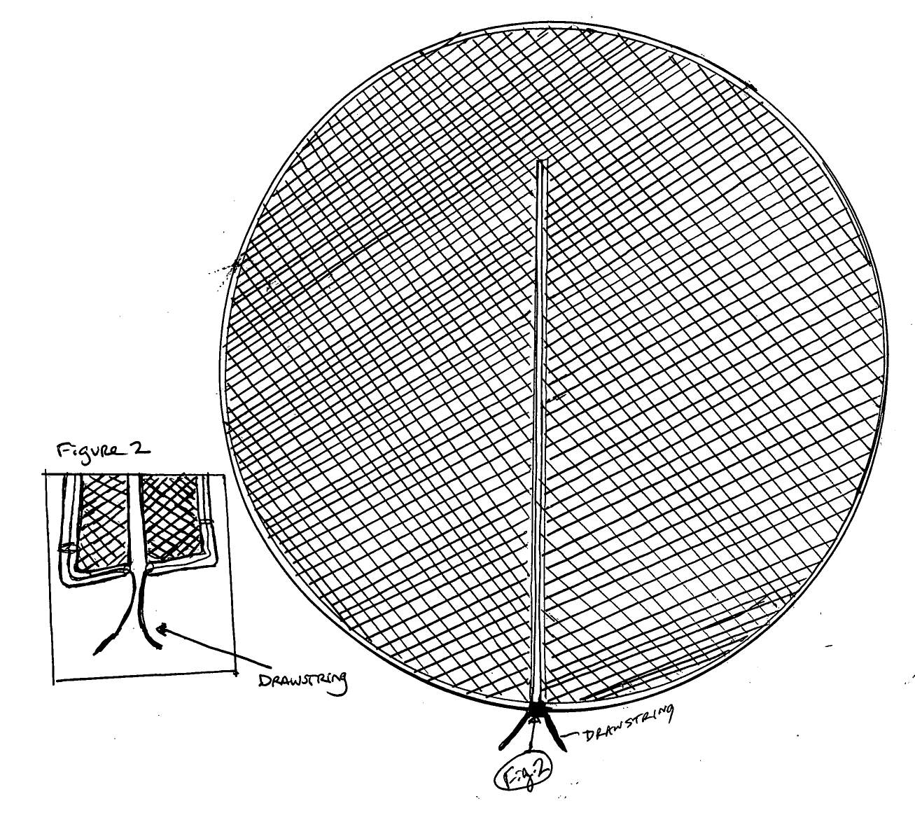

### DETAILED DESCRIPTION OF THE PREFERRED EMBODIMENTS

The present invention relates to the gathering and disposal of leaves. This invention allows one to gather the leaves without the use of a rake. The net is spread over the lawn and staked to the ground. As the leaves are blown from the trees, they fall upon the net. After the ground is covered with leaves, the stakes are taken up, the corners of the net are folded towards each other and the drawstring is pulled and tied. This net full of leaves is now ready for disposal or composting. Leaf nets can be made in all and various sizes. Leaf nets can be custom made to accommodate the individual's need. Also, for commercial and institutional use, a leaf net can be made of a thicker material. This net may be either disposable or permanent. The embodiment has been described by way of example only and modifications are possible within the scope of the invention.

What is claimed is:

1. A leaf gathering and disposal device comprised of a bio-degradable, circular net with a split along the diameter thus enabling the net to be placed around the trunk of the tree; ground stakes are used to fasten net to the ground.
